(19) United States
(12) Patent Application Publication
(10) Pub. No.: US 2010/0051430 A1
(43) Pub. Date: Mar. 4, 2010

(54) PORTABLE ELECTRONIC DEVICE AND BUTTON ASSEMBLY THEREOF

(76) Inventors: Martijn BALLER, Taipei (TW); Chi-Chen Lin, Taipei (TW); Yen-Liang Chen, Taipei (TW); Jia-Rong Lin, Taipei (TW); Chien-Hsu Hou, Taipei (TW); Meng-Hsuan Shih, Taipei (TW); Chia-Ying Lee, Taipei (TW); Wei-Chun Chien, Taipei (TW); Ching-Hao Yu, Taipei (TW); Yung-Chie Huang, Taipei (TW)

Correspondence Address: Muncy, Geissler, Olds & Lowe, PLLC, P.O. BOX 1364, FAIRFAX, VA, 22038-1364, US

(21) Appl. No.: 12/548,203

(22) Filed: Aug. 26, 2009

(30) Foreign Application Priority Data
Aug. 27, 2008 (TW) 097132702

(51) Int. Cl. H01H 9/00; H01H 3/12

(52) U.S. Cl. 200/314; 200/341

(57) ABSTRACT

A button assembly is applied to a portable electronic device having a casing. The casing has an opening. The button assembly includes a button and a circuit board. The button is disposed at the opening and has a button body and a cloth-material layer. The cloth-material layer covers at least one portion of the button body and is exposed to a surface of the casing. The circuit board is disposed in the casing. The circuit board has a switch corresponding to the button body. A portable electronic device having the button assembly is also disclosed.

### CROSS REFERENCE TO RELATED APPLICATIONS

This Non-provisional application claims priority under 35 U.S.C. §119(a) on Patent Application No(s). 097132702 filed in Taiwan, Republic of China on Aug. 27, 2008, the entire contents of which are hereby incorporated by reference.

### BACKGROUND OF THE INVENTION

1. Field of Invention

The invention relates to an electronic device and buttons thereof and, more particularly, to a portable electronic device and a button assembly thereof.

2. Related Art

A present portable electronic device, such as a notebook computer or a palmtop media player and so on, is generally light, slim, short, and small. Therefore, besides functions, a novel and special design of the portable electronic device is considered for showing a personal style.

A notebook computer is taken for example. The notebook computer generally includes a display screen and a main body with a keyboard made of rubber. The keyboard made of rubber generally does not have functions such as perspiration absorption, dust prevention and so on. When the keyboard is polluted, it is not easy to separate and clean due to the limitation of the structure and materials.

Besides functions, novelty and fashion designs are important for providing different styles of consumer electronic devices. To show a personal style is a main factor affecting purchase by consumers.

### SUMMARY OF THE INVENTION

This invention provides a portable electronic device and a keyboard assembly thereof having better touch and visual feeling.

According to an aspect of the invention, the button assembly is applied to a portable electronic device having a casing. The casing has an opening. The button assembly includes a button and a circuit board. The button is disposed at the opening and has a button body and a cloth-material layer. The cloth-material layer covers at least one portion of the button body and is exposed to a surface of the casing. The circuit board is disposed in the casing, and the circuit board has a switch corresponding to the button body.

According to another aspect of the invention, the portable electronic device includes a casing and a button assembly. The casing has an opening. The button assembly is disposed at the opening. The button assembly includes a button and a circuit board. The button has a button body and a cloth-material layer. The cloth-material layer covers at least one portion of the button body and is exposed to a surface of the casing. The circuit board is disposed in the casing, and the circuit board has a switch corresponding to the button body.

In one embodiment of the invention, the cloth-material layer may be knit fabric or non-woven fabric, and the cloth-material layer may be made of fabric, leather, or synthetic leather. The cloth-material layer may be breathable or flexible. The cloth-material layer may be separated from the button body.

In one embodiment of the invention, the cloth-material layer may fully or partly cover a surface of a character button, a number button, a function button, or a media control button. The cloth-material layer may be directly attached to a surface of the button body, or the cloth-material layer may cover the button body and float relative to the button body.

In one embodiment of the invention, the button may further have a supporting element supporting a central area of the button body. Two ends of the button body may be located at two sides of the supporting element, respectively. Thereby, when one end of the button body is pressed to contact the switch of the circuit board for generating an input signal, the other end may go up, which is similar to a seesaw. The cloth-material layer may provide a wavy visual effect by the seesaw action of the button body.

In one embodiment of the invention, the portable electronic device may be a notebook computer, a mobile communication device, a palmtop game machine, a palmtop music player (such as an MP3), or a palmtop film player (such as an MP4 or a DVD player).

In the invention, special touch feeling is provided by the cloth-material layer covering the button body of the button assembly. When the button moves up and down, the surface of the cloth-material layer ripples, thereby providing different visual feeling. If the cloth-material layer is made of different materials, different touch feeling is provided for users. Further, part of the cloth-material layer may be breathable or water-absorbent. When the cloth-material layer is polluted, the cloth-material layer can be directly replaced or be separated to clean. Different materials may be used to achieve customization as well as functions and fashion design.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a button assembly according to a preferred embodiment of the invention;

FIG. 2 is a schematic diagram showing a button assembly according to another preferred embodiment of the invention;

FIG. 3 is a schematic diagram showing a button assembly according to a third preferred embodiment of the invention;

FIG. 4 is a schematic diagram showing a lateral surface of a button assembly according to a fourth preferred embodiment of the invention; and

FIG. 5 is a schematic diagram showing a portable electronic device according to a preferred embodiment of the invention.

### DETAILED DESCRIPTION OF THE INVENTION

A portable electronic device and a keyboard assembly thereof are described in the following embodiments. The same element is described by the same reference mark.

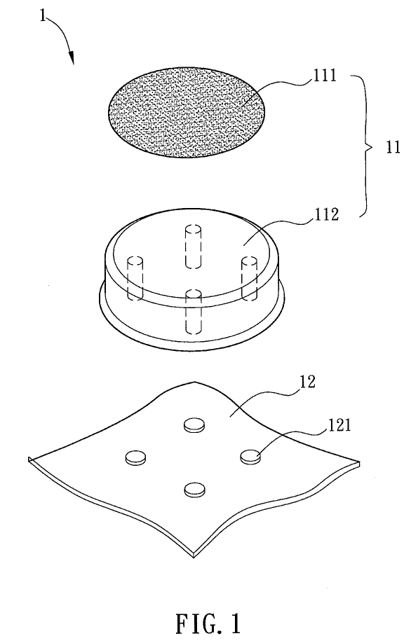

Please refer to FIG. 1. According to a preferred embodiment of the invention, a button assembly 1 includes a button 11 and a circuit board 12. The circuit board 12 corresponds to the button 11. The button 11 has a cloth-material layer 111 and a button body 112. In the embodiment, the cloth-material layer 111 fully covers a surface of the button body 112. However, the invention is not limited thereto.

The button assembly 1 may be applied to a portable electronic device having a casing. The casing has an opening. The button 11 of the button assembly 1 is disposed at the opening of the casing. The cloth-material layer 111 of the button 11 is exposed to a surface of the casing.

In addition, the button assembly 1 may be applied to a general keyboard assembly or an input button or a keyboard assembly of a mobile calculating device.

The button body 112 has a first side (such as an upper surface) and a second side (such as a lower surface) opposite to each other. The button body 112 is disposed between the cloth-material layer 111 and the circuit board 12. When the button body 112 is pressed, it contacts a switch 121 of the circuit board 12. Therefore, the circuit board 12 is triggered to generate an input signal.

The cloth-material layer 111 can be made of a plant material, an animal material, or a synthetic material such as cloth fiber, leather, or silica gel. However, the invention is not limited thereto. The cloth fiber can constitute knit fabric or non-woven fabric. The cloth-material layer 111 may be breathable or flexible. The cloth-material layer 111 may be directly attached to a surface of the button body 112, or the cloth-material layer 111 may cover the button body 112 to float relative to the button body 112.

When the button 11 is pressed, a user directly contacts the cloth-material layer 111, thereby providing different touch feeling. When the cloth-material layer 111 only covers the button body 112 to be capable of floating, the cloth-material layer 111 provides a wavy visual effect with a press of the button 11 by the user. The cloth-material layer 111 may have protruding grains, characters, numbers, figures, or patterns and so on. The user may different touch feeling by contacting the grains or patterns. Further, touch feeling can change along with the different functions or positions of the button 11.

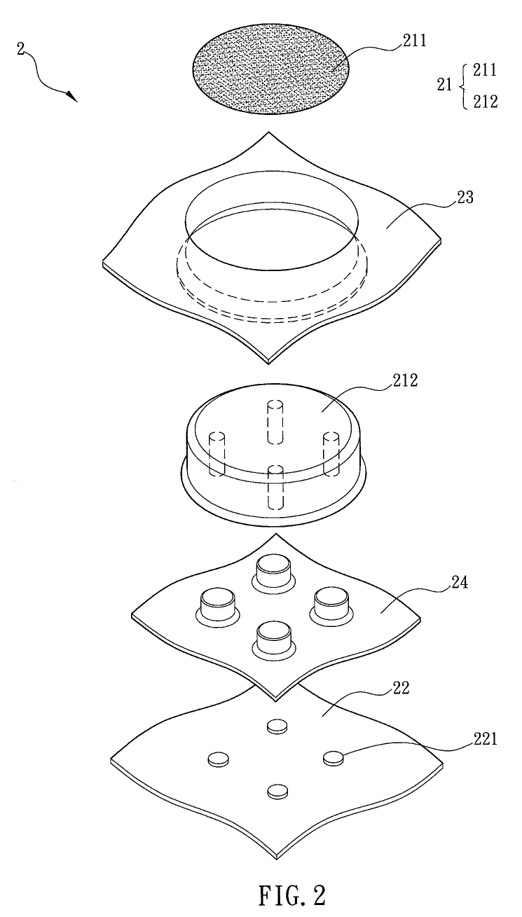

FIG. 2 is a schematic diagram showing a button assembly 2 according to another preferred embodiment of the invention. The button assembly 2 includes at least one button 21 and a circuit board 22. The button 21 includes a button body 212 and a cloth-material layer 211. The cloth-material layer 211 can partly cover the button body 212. That is, the cloth-material layer 211 covers one portion of the button body 212, and the other portion of the button body 212 is exposed. The exposed portion of the button body 212 may have patterns, protrudent portions, or recessed portions.

The button assembly 2 may further include a fastening element 23 and a cushion 24. The fastening element 23 is disposed between the button body 212 and the cloth-material layer 211 for fastening the button body 212 and preventing the button body 212 from falling. The cushion 24 is disposed between the button body 212 and the circuit board 22. When a user presses the button 21, the button body 212 is pressed and contacts the cushion 24. The cushion 24 contacts a switch 221 of the circuit board 22.

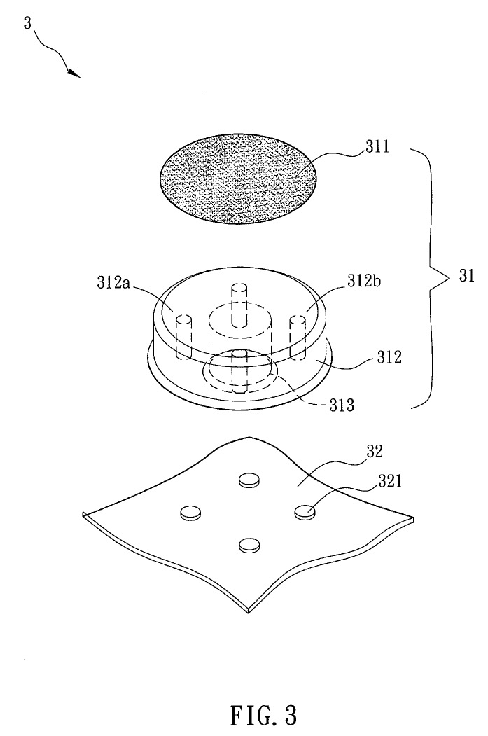

FIG. 3 is a schematic diagram showing a button assembly 3 according to a third preferred embodiment of the invention. The button assembly 3 includes a button 31 and a circuit board 32. The button 31 includes a cloth-material layer 311, a button body 312, and a supporting element 313. The cloth-material layer 311 covers the button body 312, and the circuit board 32 corresponds to the button 31. The button body 312 is disposed between the cloth-material layer 311 and the circuit board 32. The supporting element 313 is disposed between the button body 312 and the circuit board 32 for supporting the button body 312.

The button body 312 may be a four-direction button. The supporting element 313 supports a central area of the button body 312. The button body 312 has a first operation area 312a and a second operation area 312b located at two sides of the supporting element 313, respectively. The action of the first operation area 312a, the second operation area 312b, and the supporting element 313 is similar to that of a seesaw. The first operation area 312a and the second operation area 312b move around the supporting element 313 together. When the first operation area 312a is pressed, the supporting element 313 makes the second operation area 312b move upward. At that moment, if the cloth-material layer 311 can float relative to the button body 312, the cloth-material layer 311 covering the button body 312 moves with the second operation area 312b. Thereby, the cloth-material layer 311 at the first operation area 312a is recessed, and the cloth-material layer 311 at the second operation area 312b is protrudent. The cloth-material layer 311 provides a wavy visual effect. On the other hand, when the second operation area 312b is pressed, the supporting element 313 makes the first operation area 312a move upward. The first operation area 312a or the second operation area 312b contacts the circuit board 32 after pressed, thereby triggering a switch 321 of the circuit board 32 to generate an input signal.

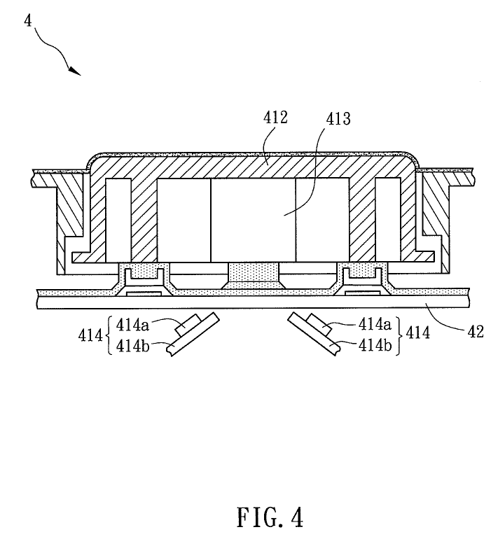

FIG. 4 is a schematic diagram showing a lateral surface of a button assembly 4 according to a fourth preferred embodiment of the invention. The button assembly 4 includes a plurality of light-guiding elements 414 disposed at one side of a circuit board 42. Thus, the circuit board 42 is located between the button body 412 and the light-guiding elements 414. The light-guiding element 414 includes a light source 414a and a light-guiding plate 414b. Light emitted from the light source 414a illuminates the button board 412 via the light-guiding plate 414b. The light-guiding elements 414 can also be disposed at other places. For example, the light-guiding elements 414 may be disposed between the button body 412 and the circuit board 42 or around the supporting element 413.

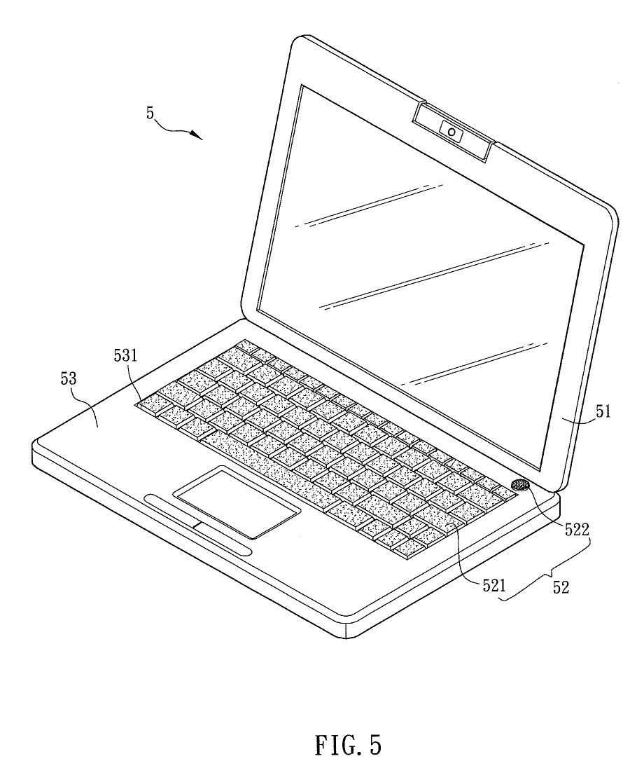

FIG. 5 is a schematic diagram showing a portable electronic device 5 according to a preferred embodiment of the invention. In the embodiment, a notebook computer as the portable electronic device 5 is taken for example. However, the invention is not limited thereto. The portable electronic device 5 includes a display module 51, a button assembly 52, a circuit board (not shown), and a casing 53. The casing 53 has an opening 531.

The circuit board is disposed in the casing 53 and located under the button assembly 52, and it generates an input signal according to a press of the button 521. The button assembly 52 includes a plurality of buttons 521, 522. The buttons 521, 522 are disposed at the opening 531 of the casing 53. Cloth-material layers of the buttons 521, 522 are exposed to a surface of the casing 53. The design and action modes of the buttons are described as the above embodiments. Therefore, they are not described for a concise purpose.

In addition, the button 521 is a button generally for inputting characters, numbers, or functions. The button 522 can have a shuttle flying function or a four-direction shape, and it may be a media control button (such as play, stop, or pause and so on) having a media adjusting function such as a volume adjusting function or a playing speed adjusting function and so on.

In addition, the portable electronic device 5 may be a mobile communication device, a palmtop game machine, a palmtop music player, or a palmtop film player and so on.

To sum up, according to the button assembly in the embodiment of the invention, touch feeling different from the prior art is provided by covering the button body of the button assembly with the cloth-material layer. When the button moves up and down, the surface of the cloth-material layer ripples, thereby providing different visual feeling. If the cloth-material layer is made of different materials, different touch feeling may be provided for users. Further, part of the cloth-material layer is breathable or water-absorbent. When the cloth-material layer is polluted, the cloth-material layer may be directly replaced or be separated to clean. Further, according to personal needs, different materials may be used to achieve customization as well as functions (practicability and convenience) and fashion design.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A button assembly applied to a portable electronic device having a casing, the casing having an opening, the button assembly comprising:
a button disposed at the opening and having a button body and a cloth-material layer, the cloth-material layer covering at least one portion of the button body and exposed to a surface of the casing; and
a circuit board disposed in the casing, the circuit board having a switch corresponding to the button body.

2. The button assembly according to claim 1, wherein the cloth-material layer is knit fabric or non-woven fabric.

3. The button assembly according to claim 1, wherein the cloth-material layer is made of fabric, leather, or synthetic leather.

4. The button assembly according to claim 1, wherein the cloth-material layer is breathable.

5. The button assembly according to claim 1, wherein the cloth-material layer is flexible.

6. The button assembly according to claim 1, wherein the cloth-material layer can be separated from the button body.

7. The button assembly according to claim 1, wherein the button is a character button, a number button, a function button, or a media control button.

8. The button assembly according to claim 1, wherein the button has a supporting element supporting a central area of the button body.

9. The button assembly according to claim 8, wherein the button body comprises two operation areas located at two sides of the supporting element, respectively, and the operation areas move around the supporting element together.

10. A portable electronic device comprising:
a casing having an opening; and
a button assembly disposed at the opening, the button assembly including:
a button having a button body and a cloth-material layer, the cloth-material layer covering at least one portion of the button body and exposed to a surface of the casing; and
a circuit board disposed in the casing, the circuit board having a switch corresponding to the button body.

11. The portable electronic device according to claim 10, wherein the cloth-material layer is knit fabric or non-woven fabric.

12. The portable electronic device according to claim 10, wherein the cloth-material layer is made of a plant material, an animal material, or a synthetic material.

13. The portable electronic device according to claim 10, wherein the cloth-material layer is breathable.

14. The portable electronic device according to claim 10, wherein the cloth-material layer is flexible.

15. The portable electronic device according to claim 10, wherein the cloth-material layer can be separated from the button body.

16. The portable electronic device according to claim 10, wherein the button is a character button, a number button, a function button, or a media control button.

17. The portable electronic device according to claim 10, wherein the button further has a light-guiding element disposed between the button body and the circuit board.

18. The portable electronic device according to claim 10, wherein the button has a supporting element supporting a central area of the button body.

19. The portable electronic device according to claim 18, wherein the button body has two operation areas located at two sides of the supporting element, respectively, and the operation areas move around the supporting element together.

20. The portable electronic device according to claim 19, wherein the button further has a light-guiding element disposed around the supporting element.

21. The portable electronic device according to claim 10, wherein the portable electronic device is a notebook computer, a mobile communication device, a palmtop game machine, a palmtop music player, or a palmtop film player.
